(19) United States
(12) Patent Application Publication
(10) Pub. No.: US 2026/0252407 A1
(43) Pub. Date: Aug. 27, 2026

(54) SYSTEMS AND METHODS FOR INTELLIGENT PROVISIONING DYNAMIC, LIFECYCLE REVISION, AND MULTI-SERVICE ORCHESTRATION IN CLOUD ENVIRONMENTS

(71) Applicant: Quantum Integrators Group, LLC, West Windsor, NJ (US)

(72) Inventors: Sandeep Srivastav, Pune (IN); Sandeep Kumar, Katy, TX (US)

(73) Assignee: Quantum Integrators Group, LLC, West Windsor, NJ (US)

(21) Appl. No.: 19/550,550

(22) Filed: Feb. 26, 2026

Related U.S. Application Data
(60) Provisional application No. 63/763,660, filed on Feb. 26, 2025.

(51) Int. Cl. G06F 9/50; G06F 8/658; G06F 11/30

(52) U.S. Cl. CPC G06F 9/5072; G06F 8/658; G06F 11/3006

(57) ABSTRACT

Techniques for migrating a platform to a cloud environment are provided. The techniques may include receiving a user input. The user input may include instructions to provision and configure a computer system application to a target cloud environment. The techniques may also include reading information from on-premise computer system application. The techniques may also include generating a cloud build plan according to information from the on-premise computer system application. The techniques may also include provisioning, based on the cloud build plan, resources for the target cloud environment. The techniques may also include configuring a computer system application in the target cloud environment according to the build plan.

### CROSS-REFERENCE TO RELATED APPLICATIONS

The present application claims priority to U.S. Provisional Patent Application No. 63/763,660, filed Feb. 26, 2025, the contents of which are incorporated by reference herein in its entirety.

### TECHNICAL FIELD

The present disclosure relates to cloud computing systems and methods for intelligent provisioning, dynamic lifecycle revision of provisioned infrastructure without restart, dynamic plan attachment, multi-service orchestration, and artificial intelligence (AI) service lifecycle management within a unified platform.

### BACKGROUND

This section is intended to introduce various aspects of the art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Lifecycle operations, including infrastructure provisioning, application migration, and the maintenance of IT applications and related infrastructure, are essential for keeping IT systems up-to-date and aligned with organizational goals and business needs to ensure efficient and secure operations. These processes help optimize performance, reduce downtime, and enhance scalability, while also addressing emerging security threats and compliance requirements. Proper lifecycle management ensures that IT resources are effectively utilized, minimizing costs and maximizing the value of technology investments.

### BRIEF SUMMARY

The invention provides an integrated platform for provisioning cloud infrastructure, dynamically revising provisioned resources without requiring restart, attaching updated execution plans, managing complete infrastructure lifecycle operations, and orchestrating multiple enterprise and AI services through a unified interface.

According to an aspect of the present disclosure, a computer-implemented method for migrating a computer system IT platform to a cloud environment may be provided. The method may include receiving a user input, the user input including instructions to provision and configure a computer system application to a target cloud environment. The method may include reading information from the computer system application in source/on-premise IT environment. The method may include generating a cloud build plan according to information from the computer system application in source/on-premise IT environment and the user input. The method may include provisioning, based on the cloud build plan, resources for the target cloud environment. The method may include configuring the target cloud environment according to the build plan.

According to other aspects of the present disclosure, the method may include one or more of the following features. The method may further include receiving target characteristics for the target cloud environment. The method may further include validating the user input. The method may further include reading information and status of the computer system application and target cloud environment. The method may further include scheduling the build plan. The method may further include executing the build plan. The method may further include adjusting a system configuration. The method may further include starting and/or stopping the computer system application and/or the target cloud environment. The method may further include patching an operating system in the target cloud environment. The method may further include copying application data from at least one server in the target cloud environment to at least one other server in the target cloud environment. The method may further include continuously monitoring the target cloud environment. The resources may include at least one of a virtual server, virtual network, and virtual database.

According to another aspect of the present disclosure, a system may be provided. The system may include one or more processing units. The system may include a non-transitory computer readable medium coupled to the one or more processing units, the non-transitory computer readable medium containing instructions that, when executed, configure the one or more processing units to, collectively: receive a user input, the user input including instructions to provision and configure a client server to a target cloud environment; read information from the computer system application in source/on-premise IT environment; generate a cloud build plan according to information from the computer system application in source/on-premise IT environment and the user input; provision, based on the cloud build plan, resources for the target cloud; and configure the target cloud platform according to the build plan.

According to other aspects of the present disclosure, the system may include one or more of the following features. The one or more processing units may be further configured to validate the user input. The one or more processing units may be further configured to read a status of the computer system application. The one or more processing units may be further configured to schedule the build plan. The one or more processing units may be further configured to execute the build plan. The one or more processing units may be further configured to adjust a system configuration. The one or more processing units may be further configured to start and/or stop the computer system application. The one or more processing units may be further configured to patch an operating system in the target cloud environment. The one or more processing units may be further configured to copy application data from at least one server in the target cloud environment to at least one other server in the target cloud environment. The one or more processing units may be further configured to continuously monitor the target cloud environment.

According to another aspect of the present disclosure, a computer-implemented method for dynamic lifecycle management of provisioned cloud infrastructure may be provided. The method may include provisioning cloud resources. The method may include storing lifecycle metadata. The method may include receiving revision instructions. The method may include generating a delta execution plan. The method may include modifying a configuration without requiring server restart.

According to other aspects of the present disclosure, the method may include one or more of the following features. Modifying the configuration may include dynamic CPU, memory, storage, and network scaling. Configuration updates may be applied through hot configuration reload mechanisms. The method may further include attaching an updated provisioning plan to an existing infrastructure. When attaching an updated provisioning plan to existing infrastructure, only differential configuration changes may be executed. The method may further include maintaining version-controlled execution plans. The method may further include rollback to a previous configuration state.

According to another aspect of the present disclosure, a unified multi-service orchestration system may be provided. The unified multi-service orchestration system may include a service registry. The unified multi-service orchestration system may include a lifecycle engine. The unified multi-service orchestration system may include a unified visualization interface.

According to other aspects of the present disclosure, the unified multi-service orchestration system may include one or more of the following features. Registered services may include enterprise applications and AI services. The unified multi-service orchestration system may further include an AI model deployment module and a runtime scaling module. The lifecycle engine may be a common lifecycle engine, and each service in the unified multi-service orchestration system may define lifecycle hooks managed through a common lifecycle engine. Revision operations may be executed without downtime.

Additional objects, advantages, and novel features of the present disclosure will be set forth in part in the description which follows, and in part will become apparent to those skilled in the art upon examination of the following or may be learned by practice of the systems, methods and apparatus described in the present disclosure.

### BRIEF DESCRIPTION OF THE DRAWINGS

The accompanying drawings, which are incorporated in and constitute a part of this specification, illustrate embodiments of the present disclosure and, together with a general description of the present disclosure given above, and the detailed description of the embodiments given below, serve to explain the principles of the present disclosure.

FIG. 1 shows a high-level block diagram of a system suitable for use in implementing the various embodiments.

FIG. 2 shows a flow diagram illustrating a method of generating a migration plan for migrating data from a client platform to a target cloud environment.

FIG. 3 shows a flow diagram illustrating a method of managing cloud platform in cloud environment.

FIG. 4 shows a block diagram illustrating a computing environment, according to example embodiments.

FIG. 5 shows a block diagram illustrating an exemplary implementation of migrating a source environment.

FIG. 6 shows a block diagram illustrating an exemplary implementation of monitoring a cloud environment after migration.

FIG. 7 illustrates a flowchart for a method for dynamic lifecycle management of provisioned cloud infrastructure.

FIG. 8 illustrates a block diagram of a unified multi-service orchestration system.

It should be understood that the appended drawings are not necessarily to scale, presenting a somewhat simplified representation of various features illustrative of the basic principles of the present disclosure. The specific design features of the sequence of operation as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following drawings merely illustrate the principles of the present disclosure. It will thus be appreciated that those skilled in the art will be able to devise various arrangements that, although not explicitly described or shown herein, embody the principles of the present disclosure and are included within its scope. Furthermore, all examples recited herein are principally intended expressly to be only for illustrative purposes to aid the reader in understanding the principles of the present disclosure and the concepts contributed by the inventor(s) to further the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present disclosure will be described with particular reference to certain embodiments. However, it should be understood that this class of embodiments provides only a few examples of the many advantageous uses of the innovative teachings herein. In general, statements made in the specification of the present disclosure do not necessarily limit any of the various claims. Moreover, some statements may apply to some inventive features but not to others. Those skilled in the art and informed by the teachings herein will realize that the present disclosure is also applicable to various other technical areas or embodiments.

Lifecycle operations, including infrastructure provisioning, application migration, and the maintenance of computer system IT applications and associated IT infrastructure, are essential for ensuring computer system IT systems remain up-to-date and aligned with organizational goals and business needs, facilitating efficient and secure operations. Maintenance operations primarily consist of system startups and shutdowns, patching, and updates to maintain system security and performance.

IT Infrastructure provisioning may involve steps for creating systems and applications in a designated infrastructure environment and setting them up to defined standards to properly configure an IT system.

The migration of a computer system IT application requires thorough analysis to assess the current application status, followed by the migration of its configuration, data, and interfaces to newly provisioned target IT systems.

These tasks are often carried out in stages, adding complexity due to the use of different tools and processes. The disclosure outlined here aims to integrate all the necessary steps to streamline infrastructure provisioning, application migration, and the ongoing lifecycle management of IT infrastructure.

Various embodiments are designed to support the lifecycle of migrating SAP and non-SAP workloads to a cloud environment, with compatibility across different cloud platforms. In some embodiments, the migration and management of these workloads are streamlined for simplicity.

A key feature of these embodiments is a modular design, allowing independent components to be seamlessly integrated. Security is a primary focus, with strong measures in place to protect data and operations within cloud environments. Some embodiments also include lifecycle management capabilities, such as patching, upgrades, and the ability to manage SAP ecosystems after migration. Furthermore, customization options are available to enable the creation of tailored workflows and orchestration that meet specific business needs.

Additionally, some embodiments provide a clear, high-level diagram or overview of a platform's architecture and capabilities, highlighting the ease of onboarding and the immediate benefits users can experience within the first hour of deployment.

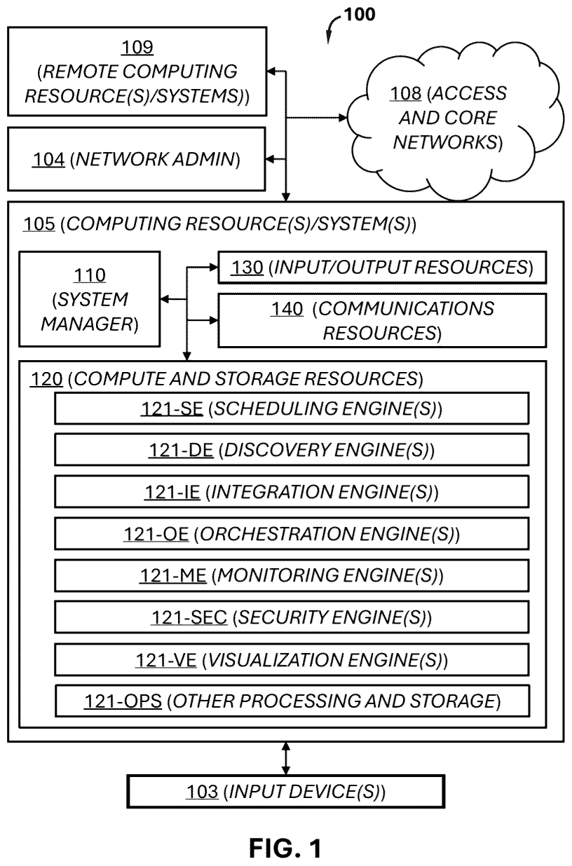

Referring now to FIG. 1, a high-level block diagram of a system suitable for use in implementing the various embodiments is shown. Specifically, the system 100 of FIG. 1 comprises one or more data processing elements, computing devices, network elements and the like cooperating as described herein to implement various embodiments. Not all of the described data processing elements, computing devices, network elements and the like are necessary to implement each embodiment.

The system 100 of FIG. 1 may be implemented via one or more servers, workstations, and/or other computing and memory providing devices operating in accordance with the various embodiments, such as described herein and with respect to the various other figures.

The system 100 of FIG. 1 may be implemented within the context of one or more data centers having instantiated therein compute and memory/storage resources configured in accordance with the embodiments described herein.

It is noted that systems/embodiments described herein are provided for illustrative purposes only. Other combinations of computing, memory, networking, applications, and so on may be used to implement the various embodiments.

As shown in FIG. 1, computing resource(s)/system(s) 105 are depicted as comprising a system manager 110, compute (processing) and storage (memory) resources 120, input/output resources 130, and communications resources 140.

Generally speaking, the system manager 110 may be used to control various aspects of the computing resource(s)/system(s) 105, such as the configuration, management, and/or operational control of the individual elements/resources forming the computing resource(s)/system(s) 105, and so on. In various embodiments a system manager 110 is not used; rather, the individual elements/resources are configured for operation without the use of a local system manager 110 such as via a remote system manager (not shown), or other control/management entity.

As shown in FIG. 1, the compute and storage resources 120 of the computing resource(s)/system(s) 105 are used to implement various processors or modules in accordance with the embodiments or portions thereof, including a scheduling engine 121-SE, discovery engine 121-DE, Integration engine 121-IE, Orchestration engine 121-OE, monitoring engine 121-ME, security engine 121-SE, visualization engine 121-VE, as well as other processing and storage 121-OPS. Each of these resources are described herein.

The scheduling engine 121-SE may be used to schedule an action. The actions may include, for example, provisioning a server in a target infrastructure at a planned date and time. The discovery engine 121-DE may be configured to automatically detect and inventory all relevant system components and configurations of a client platform. The integration engine 121-IE may provide all the connectors to connect different systems. The systems may include, for example, customer databases via java database connectivity, and/or servers using SSH protocol to execute an action in a client platform and cloud platform. The orchestration engine 121-OE may be used to execute sequences of events in a controlled way. The monitoring engine 121-ME may collect and analyze the alerts from various connected systems and process them. The security engine 121-SE may be configured to enhance the platform's security features, ensuring robust role-based access control and auditing capabilities. The visualization engine 121-VE may be used to enhance or modify various visual screens to user preference. Additionally, the engines are optimized to improve the platform's ability to support custom workflows and integrate with other tools and systems. Together, these modules offer users the flexibility to customize the product to meet their specific needs and environments.

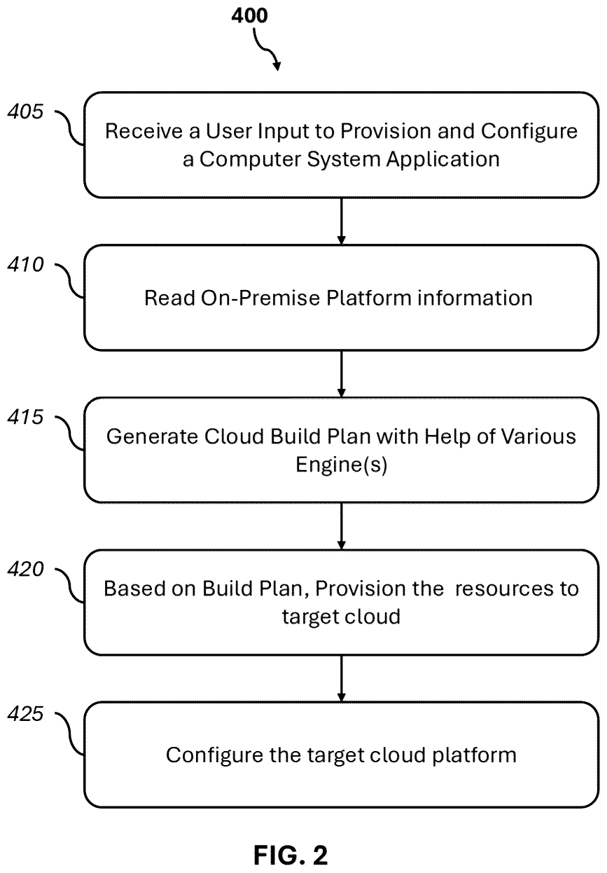

In various aspects a computer-implemented method 400 may be provided. Referring now to FIG. 2, the computer-implemented method may include receiving 405, by a computing system, a request to provision and configure a computer system application to a cloud environment. The request may be received by an external network connection, e.g., a customer may place an order for provisioning the server through the product.

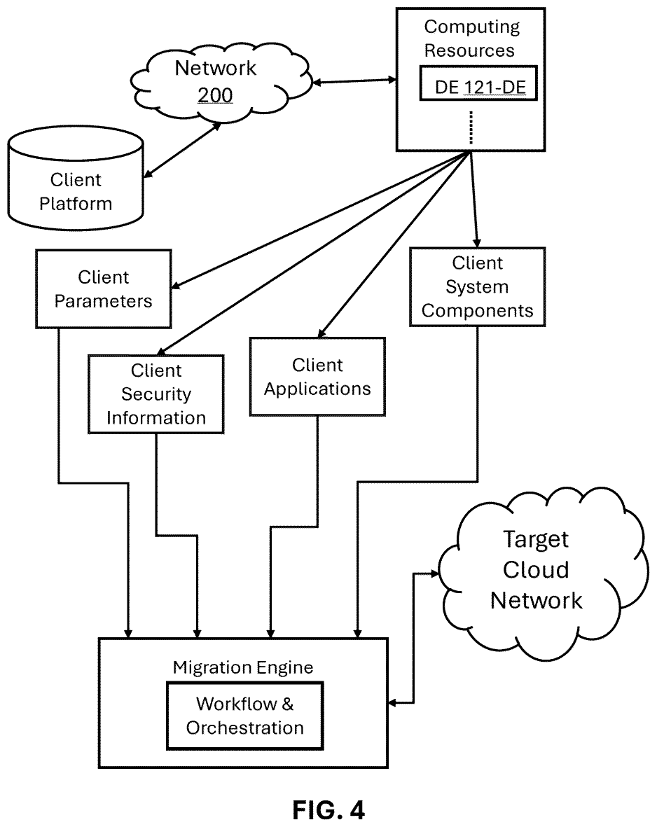

In some embodiments, the method may include reading 410, by the computing system, on-premise platform information. Referring now to FIG. 4, a block diagram illustrating a computing environment is shown. Reading on-premise platform information may be accomplished via one or more networks 200. As shown in FIG. 4, the network 200 may access not only the client platform, but may also access the computing resources, and either directly or indirectly, client system information (e.g., client system components, client parameters, client security information, client applications, and the target cloud network).

The network 200, may be representative of any suitable type, including individual connections via the Internet, such as cellular or Wi-Fi networks. In some embodiments, network 200 may connect terminals, services, and mobile devices using direct connections, such as radio frequency identification (RFID), near-field communication (NFC), Bluetooth, low-energy Bluetooth, USB, WAN, or LAN. Because the information transmitted may be personal or confidential, security concerns may dictate one or more of these types of connection may be encrypted or otherwise secured.

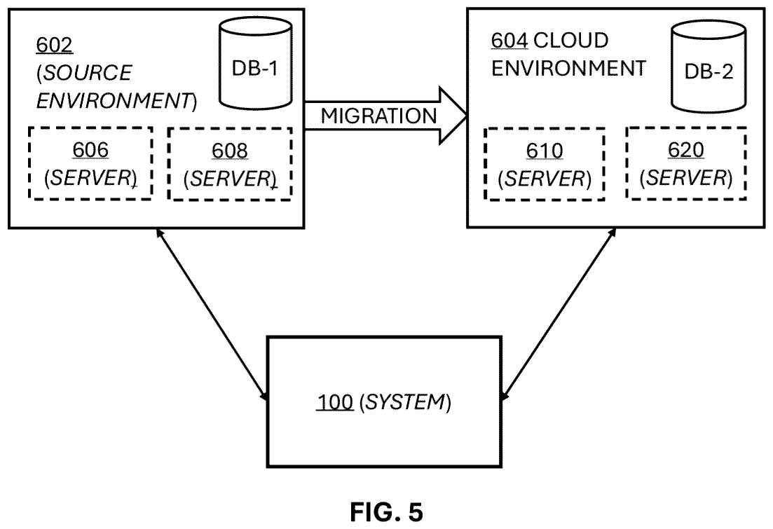

Referring back to FIG. 2, the method may include generating 415, by the computing system, a cloud build plan. In some embodiments, generating the cloud build plan may include preparing the build plan. The build plan may include a set of instructions for a target hyperscaler based on information stored in a server information model/configuration management database (CMDB) to create cloud resources. The build plan may comprise information needed to provision resources and verify them before execution. Further, the method may include, based on the build plan, provisioning 420 the resources to the target cloud. This step may be used to connect cloud environment to execute build action. The method may also include configuring 425 the cloud platform by executing one or more actions. The one or more actions may include, for example, installation of any software application similar to a source environment. The one or more actions may also include changing certain environmental configurations using, using at least one of the integration engine, scheduling engine, and orchestrator engine to align with a source environment (see FIG. 5).

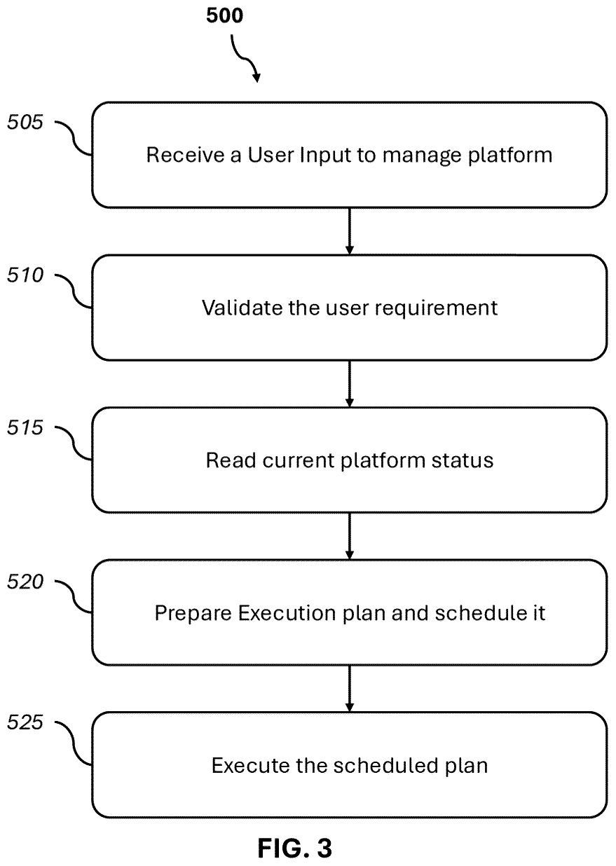

Referring now to FIG. 3, an embodiment of a computer-implemented method 500 for managing a cloud environment is shown. In some embodiments, a user may provide an input via a product interface to manage a client platform. The method may include receiving 505 the user input to manage a platform. In some embodiments, the method may include validating 510 a user requirement. Activity may need to be validated by various engines. In some embodiments, reading 515 the current platform status may be used to validate connected systems for correctness of action. The method may include preparing and scheduling 520 the execution plan. In some embodiments preparing and scheduling 520 the execution plan may include preparing and finalizing a list of all the necessary actions. The necessary actions may depend on user input. For example, if a user wants a scheduled shutdown at certain date and time, the necessary actions may include preparing a plan including all the steps necessary to stop relevant applications and databases followed by server shutdown. For server patching, additional steps of operating system patching may be included over required steps to stop and start applications. The method may include executing 525 the scheduled plan.

Referring now to FIG. 5, an illustrative implementation of the various presently disclosed systems and methods is shown. The system 100 communicates with a source environment 602. The source environment having at least one server 606 or 608 and at least one database DB-1. The system 100 then migrates the at least one server 606 or 608 and at least one database DB-1 to the cloud environment 604. The cloud environment then operates with at least one configured server 610 or 620 and at least one database DB-2.

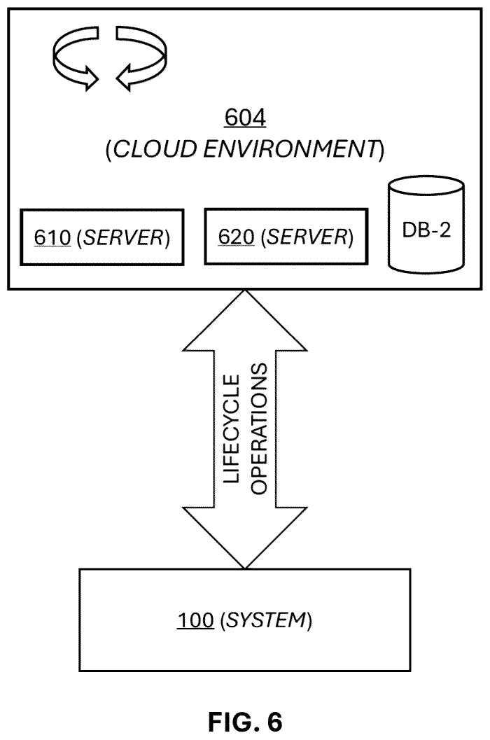

Referring now to FIG. 6, another illustrative implementation of the various presently disclosed systems and methods is shown. Here, the system 100 continuously communicates with the cloud environment 604 after the source environment has been migrated. The system communicates with the servers 610 and 620 and database DB-2 and performs various lifecycle management operations. These various lifecycle management operations, may include at least one of, adjusting the configurations of the cloud environment, starting and/or stopping the source environment and/or the target cloud environment, patching an operating system, copying application data from server 610 to server 620, and continuously monitoring the target cloud environment.

The various steps of the computer-implemented method may be accomplished via any suitable arrangement of computer programs or architectures.

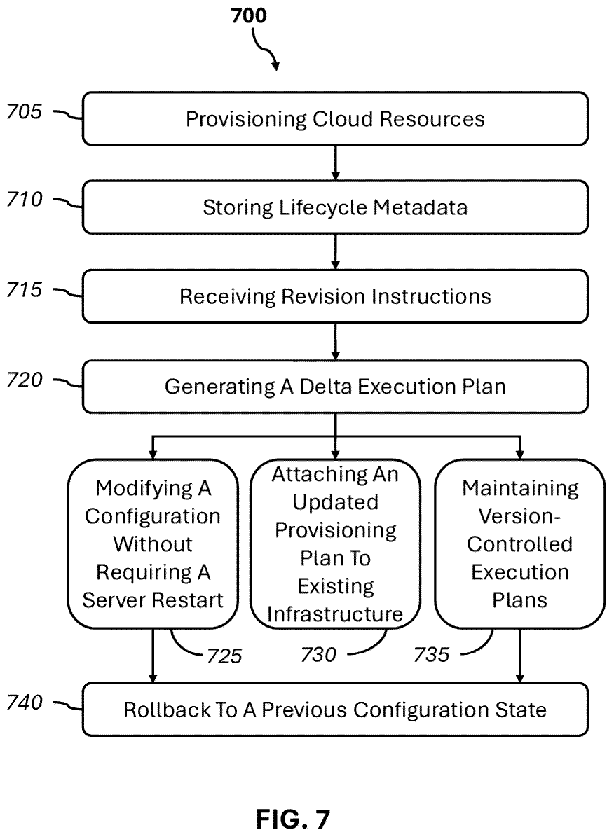

FIG. 7 illustrates a flowchart for a method 700 for dynamic lifecycle management of provisioned cloud infrastructure. The method 700 begins with a step 705, where cloud resources are provisioned. The method 700 then proceeds to a step 710, where lifecycle metadata is stored. The lifecycle metadata may include configuration parameters, resource allocations, timestamps, and version information associated with the provisioned cloud resources. Following this, the method 700 moves to a step 715, where revision instructions are received. The revision instructions may specify changes to the cloud infrastructure configuration, resource scaling requirements, or other modifications to the provisioned environment. The method 700 then advances to a step 720, where a delta execution plan is generated. The delta execution plan identifies the differences between the current configuration state and the desired configuration state, enabling efficient application of only the necessary changes.

From step 720, the method 700 branches into three potentially parallel operations. A step 725 involves modifying a configuration without requiring a server restart. Modifying the configuration may include dynamic CPU, memory, storage, and network scaling. Dynamic CPU scaling allows adjustment of processing capacity allocated to virtual machines or containers without interrupting running workloads. Dynamic memory scaling enables modification of RAM allocations to accommodate changing application demands. Dynamic storage scaling permits expansion or contraction of storage volumes and throughput parameters. Dynamic network scaling allows adjustment of bandwidth allocations, network interface configurations, and connectivity parameters. Configuration updates may be applied through hot configuration reload mechanisms. Hot configuration reload mechanisms enable the system to apply new configuration parameters to running services without requiring service interruption or server restart. These mechanisms may include live migration of workloads, in-place memory updates, and runtime parameter injection.

A step 730 involves attaching an updated provisioning plan to existing infrastructure. When an updated provisioning plan is attached to existing infrastructure, the system compares the updated plan against the current infrastructure state. In some cases, only differential configuration changes are executed. By executing only differential configuration changes, the system minimizes disruption to running services and reduces the time required to implement infrastructure modifications. The differential approach identifies resources that require creation, modification, or deletion and executes only those specific operations.

A step 735 involves maintaining version-controlled execution plans. Version-controlled execution plans provide a historical record of all configuration states and the transitions between them. Each execution plan version captures the complete infrastructure specification at a point in time, enabling tracking of changes, auditing of modifications, and comparison between different configuration states.

The method 700 then converges to a step 740, where a rollback to a previous configuration state may be performed. Rollback to a previous configuration state enables the system to revert infrastructure to a known good state in the event of configuration errors, performance degradation, or other issues arising from recent changes. The rollback operation utilizes the version-controlled execution plans to identify the target configuration state and generates a delta execution plan to transition from the current state to the previous state. This capability provides operational resilience and reduces risk associated with infrastructure modifications.

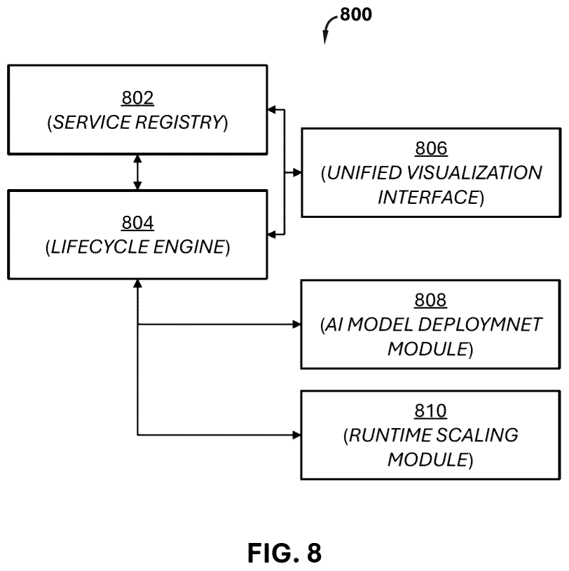

FIG. 8 illustrates a block diagram of a unified multi-service orchestration system 800. The unified multi-service orchestration system 800 includes a service registry 802, a lifecycle engine 804, a unified visualization interface 806, an AI model deployment module 808, and a runtime scaling module 810. The service registry 802 is configured to allow services to register within the unified multi-service orchestration system 800. Registered services may include enterprise applications and AI services. The service registry 802 maintains a catalog of all registered services, including their configurations, dependencies, and operational parameters. When a new service is registered, the service registry 802 captures the service metadata and makes the service available for lifecycle management and orchestration operations.

The lifecycle engine 804 is coupled to the service registry 802 and manages lifecycle operations for each service registered in the unified multi-service orchestration system 800. The lifecycle engine 804 may be a common lifecycle engine, and each service in the unified multi-service orchestration system 800 defines lifecycle hooks managed through the common lifecycle engine. Lifecycle hooks enable services to specify custom actions that execute during lifecycle transitions, such as startup, shutdown, scaling, and configuration updates. By utilizing a common lifecycle engine, the unified multi-service orchestration system 800 provides consistent lifecycle management across heterogeneous service types.

The unified visualization interface 806 is connected to the lifecycle engine 804 and provides a common interface for viewing and managing the registered services. The unified visualization interface 806 presents a consolidated view of all services, their current states, resource utilization, and operational metrics. Through the unified visualization interface 806, operators can monitor service health, initiate lifecycle operations, and view historical performance data across all registered services from a single interface.

The AI model deployment module 808 is connected to the lifecycle engine 804 and facilitates the deployment of AI models within the unified multi-service orchestration system 800. The AI model deployment module 808 handles the provisioning of compute resources required for AI model inference, manages model versioning, and coordinates the deployment of updated models to production environments.

The runtime scaling module 810 is connected to the lifecycle engine 804 and enables dynamic scaling of resources during runtime operations. The runtime scaling module 810 monitors resource utilization and workload demands, and automatically adjusts resource allocations to meet performance requirements. The runtime scaling module 810 may scale resources horizontally by adding or removing service instances, or vertically by adjusting compute, memory, and storage allocations for existing instances.

Revision operations within the unified multi-service orchestration system 800 are executed without downtime. The lifecycle engine 804 coordinates revision operations by utilizing rolling updates, blue-green deployments, or canary release strategies to ensure continuous service availability during configuration changes and updates. When a revision operation is initiated, the lifecycle engine 804 orchestrates the transition from the current configuration to the updated configuration while maintaining service continuity for end users.

The unified multi-service orchestration system 800 may further include a dynamic revision engine that enables delta-based configuration changes without server restart. The dynamic revision engine analyzes incoming revision requests and determines the minimal set of changes required to transition from the current configuration state to the desired configuration state. Rather than applying a complete configuration replacement, the dynamic revision engine identifies specific parameters, resources, or settings that differ between states and applies only those modifications. This delta-based approach reduces the scope of changes applied to running infrastructure, thereby minimizing the risk of unintended side effects and reducing the time required to complete revision operations. The dynamic revision engine interfaces with the lifecycle engine 804 to coordinate the application of configuration changes across registered services. When a delta-based configuration change is initiated, the dynamic revision engine generates a change manifest that specifies each modification to be applied, the order of application, and any dependencies between changes. The dynamic revision engine then executes the change manifest while monitoring the health and status of affected services. If an issue is detected during the application of changes, the dynamic revision engine may pause execution, alert operators, or automatically initiate corrective actions.

The unified multi-service orchestration system 800 may further include a lifecycle management module that supports a comprehensive set of lifecycle operations including provisioning, scaling, patching, cloning, rollback, and retirement. Provisioning operations allocate and configure new resources for services, including compute instances, storage volumes, network configurations, and associated infrastructure components. Scaling operations adjust resource allocations in response to changing workload demands, and may include both horizontal scaling through the addition or removal of service instances and vertical scaling through the modification of resource allocations for existing instances. Patching operations apply security updates, bug fixes, and feature enhancements to operating systems, middleware, and application components within the managed infrastructure. The lifecycle management module coordinates patching operations to minimize service disruption, utilizing techniques such as rolling updates and maintenance windows. Cloning operations create copies of existing service configurations and associated resources, enabling rapid deployment of new environments for testing, development, or disaster recovery purposes. Rollback operations revert services to previous configuration states, utilizing version-controlled execution plans to identify target states and generate the necessary transition plans. Retirement operations decommission services that are no longer required, including the orderly shutdown of service instances, the release of allocated resources, and the archival of associated data and configuration information.

The unified multi-service orchestration system 800 may further include a dynamic plan versioning component that supports plan branching, merging, incremental execution, and rollback. Plan branching enables the creation of alternative configuration paths from a common baseline, allowing operators to develop and test configuration changes in isolation before applying them to production environments. When a plan branch is created, the dynamic plan versioning component captures the current configuration state as a branch point and tracks subsequent modifications independently from the main configuration line. Plan merging combines changes from multiple branches into a unified configuration, resolving conflicts between divergent modifications and producing a consolidated execution plan. The dynamic plan versioning component provides tools for comparing branch configurations, identifying conflicts, and specifying resolution strategies. Incremental execution enables the application of execution plans in stages, with validation and verification steps between stages. This approach allows operators to monitor the effects of partial plan execution and make adjustments before proceeding with subsequent stages. The dynamic plan versioning component maintains execution state information that tracks which portions of a plan have been applied and which remain pending. Rollback capabilities within the dynamic plan versioning component enable reversion to any previously recorded configuration state, utilizing the version history to generate delta execution plans that transition from the current state to the target historical state.

The unified multi-service orchestration system 800 supports multi-service registration that allows enterprise applications and AI services to register under a unified user interface. The service registry 802 provides a common registration mechanism that accepts service definitions from diverse service types, including traditional enterprise applications, microservices, containerized workloads, and AI inference services. When a service registers with the service registry 802, the registration process captures service metadata including service name, version, resource requirements, dependency specifications, health check endpoints, and lifecycle hook definitions. The unified visualization interface 806 presents all registered services through a common interface regardless of service type, enabling operators to view and manage enterprise applications and AI services from a single consolidated dashboard. The unified user interface provides consistent navigation, filtering, and search capabilities across all registered services, and presents service-specific details and controls appropriate to each service type. For AI services, the unified user interface may display model version information, inference performance metrics, and deployment status. For enterprise applications, the unified user interface may display application health indicators, transaction volumes, and resource utilization statistics. The multi-service registration capability enables organizations to consolidate management of heterogeneous service portfolios under a single orchestration platform, reducing operational complexity and improving visibility across the service landscape.

The unified multi-service orchestration system 800 provides AI lifecycle orchestration capabilities that manage the complete lifecycle of AI models from initial deployment through ongoing operation and eventual retirement. AI lifecycle orchestration encompasses model registration, where AI models are cataloged within the service registry 802 along with associated metadata including model architecture, training parameters, input and output specifications, and performance benchmarks. The AI model deployment module 808 coordinates the deployment of registered models to inference infrastructure, allocating appropriate compute resources based on model requirements and expected workload characteristics. During deployment, the AI model deployment module 808 configures model serving endpoints, establishes health monitoring, and integrates the deployed model with the unified visualization interface 806 for operational visibility.

AI lifecycle orchestration further includes model versioning and update management. When updated model versions become available, the lifecycle engine 804 coordinates the transition from current model versions to updated versions using deployment strategies that maintain inference availability. The lifecycle engine 804 may implement A/B testing configurations that route a portion of inference requests to updated model versions while monitoring performance metrics to validate model behavior before full deployment. Model performance monitoring tracks inference latency, throughput, accuracy metrics, and resource utilization, enabling operators to identify performance degradation or drift that may indicate the need for model retraining or replacement.

The runtime scaling module 810 provides inference scaling capabilities that adjust compute resources allocated to AI models based on inference demand. During periods of high inference volume, the runtime scaling module 810 may provision additional inference instances to maintain response time targets. During periods of low demand, the runtime scaling module 810 may reduce allocated resources to optimize cost efficiency. The runtime scaling module 810 supports both reactive scaling based on observed metrics and predictive scaling based on anticipated workload patterns.

Although various embodiments which incorporate the teachings of the present disclosure have been shown and described in detail herein, those skilled in the art can readily devise many other varied embodiments that still incorporate these teachings. Thus, while the foregoing is directed to various embodiments, other and further embodiments may be devised without departing from the basic scope thereof. As such, the appropriate scope of the present disclosure is determined according to the claims.

What is claimed is:

1. A computer-implemented method for migrating a computer system IT platform to a cloud environment, comprising:
receiving a user input, the user input comprising instructions to provision and configure a computer system application to a target cloud environment;
reading information from the computer system application in source/on-premise IT environment;
generating a cloud build plan according to information from the computer system application in source/on-premise IT environment and the user input;
provisioning, based on the cloud build plan, resources for the target cloud environment; and
configuring the target cloud environment according to the build plan.

2. The computer-implemented method of claim 1, further comprising receiving target characteristics for the target cloud environment.

3. The computer-implemented method of claim 1, further comprising validating the user input.

4. The computer-implemented method of claim 1, further comprising reading information and status of the computer system application and target cloud environment.

5. The computer-implemented method of claim 1, further comprising scheduling the build plan.

6. The computer-implemented method of claim 1, further comprising executing the build plan.

7. The computer-implemented method of claim 1, further comprising adjusting a system configuration.

8. The computer-implemented method of claim 1, further comprising starting and/or stopping the computer system application and/or the target cloud environment.

9. The computer-implemented method of claim 1, further comprising patching an operating system in the target cloud environment.

10. The computer-implemented method of claim 1, further comprising copying application data from at least one server in the target cloud environment to at least one other server in the target cloud environment.

11. The computer-implemented method of claim 1, further comprising continuously monitoring the target cloud environment.

12. The computer-implemented method of claim 1, wherein the resources comprise at least one of a virtual server, virtual network, and virtual database.

13. A system, comprising:
one or more processing units; and
a non-transitory computer readable medium coupled to the one or more processing units, the non-transitory computer readable medium containing instructions that, when executed, configure the one or more processing units to, collectively:
receive a user input, the user input comprising instructions to provision and configure a client server to a target cloud environment;
read information from the computer system application in source/on-premise IT environment;
generate a cloud build plan according to information from the computer system application in source/on-premise IT environment and the user input;
provision, based on the cloud build plan, resources for the target cloud; and
configure the target cloud platform according to the build plan.

14. The system of claim 13, wherein the one or more processing units are further configured to validate the user input.

15. The system of claim 13, wherein the one or more processing units are further configured to read a status of the computer system application.

16. The system of claim 13, wherein the one or more processing units are further configured to schedule the build plan.

17. The system of claim 13, wherein the one or more processing units are further configured to execute the build plan.

18. The system of claim 13, wherein the one or more processing units are further configured to adjust a system configuration.

19. The system of claim 13, wherein the one or more processing units are further configured to start and/or stop the computer system application.

20. The system of claim 13, wherein the one or more processing units are further configured to patch an operating system in the target cloud environment.

21. The system of claim 13, wherein the one or more processing units are further configured to copy application data from at least one server in the target cloud environment to at least one other server in the target cloud environment.

22. The system of claim 13, wherein the one or more processing units are further configured to continuously monitor the target cloud environment.

23. A computer-implemented method for dynamic lifecycle management of provisioned cloud infrastructure comprising:
provisioning cloud resources;
storing lifecycle metadata;
receiving revision instructions;
generating a delta execution plan; and
modifying a configuration without requiring server restart.

24. The method of claim 23, wherein modifying the configuration includes dynamic CPU, memory, storage, and network scaling.

25. The method of claim 23, wherein configuration updates are applied through hot configuration reload mechanisms.

26. The method of claim 23, further comprising attaching an updated provisioning plan to an existing infrastructure.

27. The method of claim 26, wherein only differential configuration changes are executed.

28. The method of claim 23, further comprising maintaining version-controlled execution plans.

29. The method of claim 23, further comprising rollback to a previous configuration state.

30. A unified multi-service orchestration system comprising:
a service registry;
a lifecycle engine; and
a unified visualization interface.

31. The unified multi-service orchestration system of claim 30, wherein registered services include enterprise applications and AI services.

32. The unified multi-service orchestration system of claim 31, further comprising an AI model deployment module and a runtime scaling module.

33. The unified multi-service orchestration system of claim 30, wherein the lifecycle engine is a common lifecycle engine, and each service in the unified multi-service orchestration system defines lifecycle hooks managed through a common lifecycle engine.

34. The unified multi-service orchestration system of claim 30, wherein revision operations are executed without downtime.
